(19) United States
(12) Patent Application Publication
(10) Pub. No.: US 2026/0249487 A1
(43) Pub. Date: Aug. 27, 2026

(54) ROBOT

(71) Applicant: FANUC CORPORATION, Minamitsuru-gun, Yamanashi (JP)

(72) Inventor: Tomoya KONISHI, Yamanashi (JP)

(73) Assignee: FANUC CORPORATION, Minamitsuru-gun, Yamanashi (JP)

(21) Appl. No.: 18/854,959

(22) PCT Filed: Jun. 23, 2022
(86) PCT No.: PCT/JP2022/025161

§ 371 Date: Oct. 7, 2024

(51) Int. Cl. B25J 17/02; B25J 9/00; B25J 9/10; B25J 19/00

(52) U.S. Cl. CPC B25J 17/0283; B25J 9/0024; B25J 9/104; B25J 19/0029

(57) ABSTRACT

A robot comprises at the leading end of an arm: a first wrist element rotatably supported about a first axial line; a second wrist element rotatably supported about a second axial line orthogonal to the first axial line with respect to the first wrist element; and a third wrist element rotatably supported about a third axial line orthogonal to the second axial line with respect to the second wrist element. The first wrist element is provided with a first space accommodating a first motor that drives the second wrist element, and a second motor that drives the third wrist element, and second spaces that communicate with the first space and are respectively disposed on the both sides thereof with the first space interposed therebetween along the second axial line. A wire body guided through the arm is guided through at least one of the second spaces into the first space.

This application is a national phase of International Application No. PCT/JP2022/025161 filed Jun. 23, 2022, which is incorporated herein by reference in its entirety.

### TECHNICAL FIELD

The present disclosure relates to a robot.

### BACKGROUND ART

There is a known robot in which distal two-axis wrist element motors are mounted on a three-axis wrist unit disposed at the distal end of an arm (for example, see Patent Literature 1). In this robot, the motors mounted on the wrist unit are exposed to the outside of a casing of the wrist unit, and a cable extending to the motors is also exposed.

### CITATION LIST

### Patent Literature

{PTL 1} Japanese Unexamined Patent Application, Publication No. 2012-240123

### SUMMARY OF INVENTION

An aspect of the present disclosure is a robot comprising: a first wrist element that is supported at a distal end of an arm so as to be rotatable about a first axis; a second wrist element that is supported so as to be rotatable with respect to the first wrist element about a second axis orthogonal to the first axis; and a third wrist element that is supported so as to be rotatable with respect to the second wrist element about a third axis orthogonal to the second axis, wherein the first wrist element is provided with a first space accommodating a first motor that drives the second wrist element and a second motor that drives the third wrist element, and second spaces that communicate with the first space and that are respectively disposed on both sides thereof with the first space interposed therebetween in the second axis direction, and a wire body guided through the arm is guided into the first space through at least one of the second spaces.

### BRIEF DESCRIPTION OF DRAWINGS

FIG. 1 is a partial longitudinal sectional view showing a robot according to an embodiment of the present disclosure.

FIG. 2 is a partial longitudinal sectional view showing a state in which lid members of the robot in FIG. 1 are removed.

FIG. 3 is a diagram of the robot in FIG. 2, from which the lid members have been removed, as viewed from one side in a second axis direction.

FIG. 4 is a diagram of the robot in FIG. 2, from which the lid members have been removed, as viewed from the other side in the second axis direction.

### DESCRIPTION OF EMBODIMENT

A robot 1 according to an embodiment of the present disclosure will be described below with reference to the drawings.

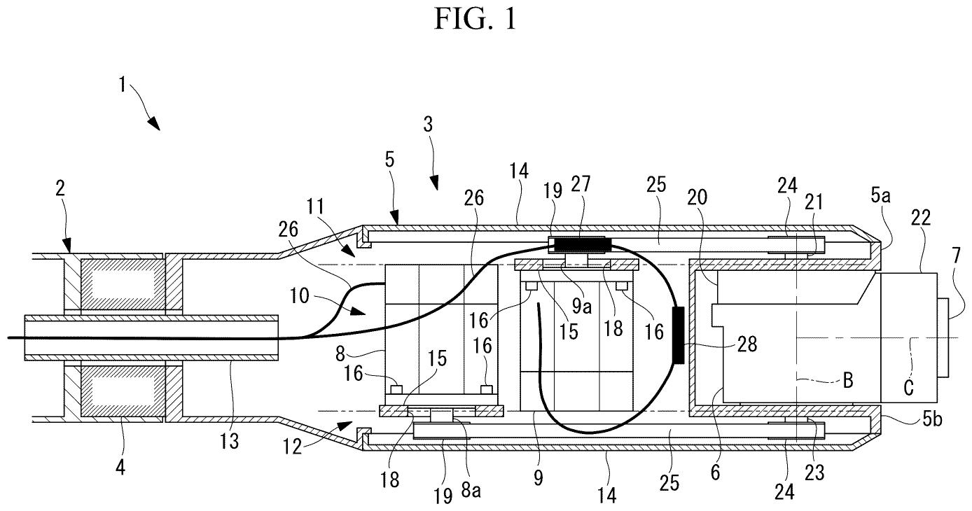

The robot 1 according to this embodiment is, for example, a vertical articulated robot. As shown in FIG. 1, the robot 1 includes a three-axis wrist unit 3 that is disposed at the distal end of an arm 2. The arm 2 and the wrist unit 3 are connected to each other by means of a reduction gear 4.

The wrist unit 3 includes a first wrist element 5 that is supported by the reduction gear 4 so as to be rotatable about a first axis A with respect to the arm 2. In addition, the wrist unit 3 includes a second wrist element 6 that is supported so as to be rotatable with respect to the first wrist element 5 about a second axis B orthogonal to the first axis A.

Furthermore, the wrist unit 3 includes a third wrist element 7 that is supported so as to be rotatable with respect to the second wrist element 6 about a third axis C orthogonal to the second axis B. The third axis C is disposed in a plane including the first axis A and orthogonal to the second axis B.

The first wrist element 5 is formed in a hollow shape. The first wrist element 5 is provided with a first space 10 that accommodates two motors (first and second motors) 8, 9 in the interior thereof. In addition, the first wrist element 5 is provided with two second spaces 11, 12 that are respectively disposed on both sides thereof with the first space 10 interposed therebetween in the second axis B direction.

The arm 2 is formed in a hollow shape and includes, in the interior thereof, a hollow pipe 13 that extends along the first axis A. The distal end of the hollow pipe 13 is open in the first space 10 of the first wrist element 5.

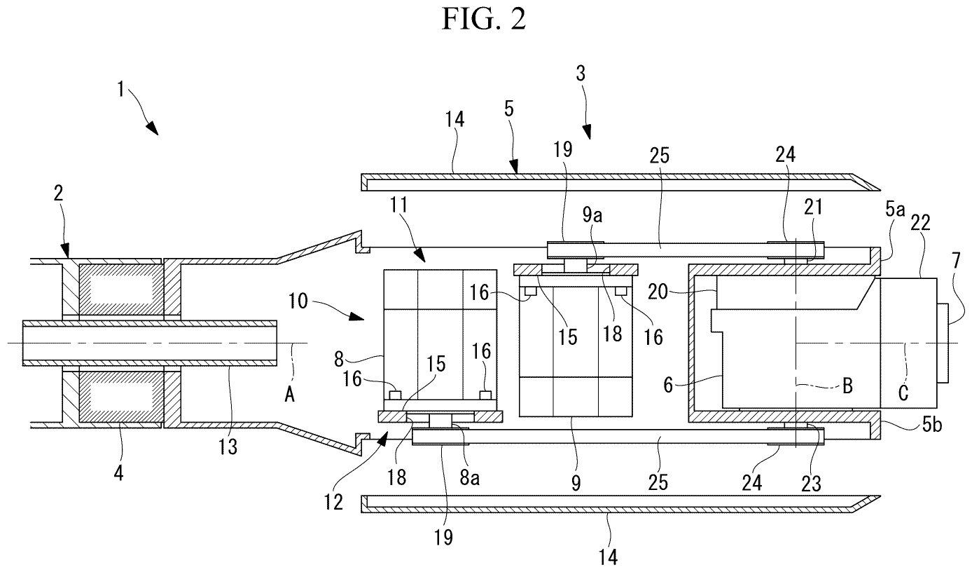

As shown in FIG. 2, the first wrist element 5 includes, on both sides thereof in the second axis B direction, lid members 14 that are detachable in the second axis B direction. By removing the lid members 14, the insides of the second spaces 11, 12 of the first wrist element 5 can be exposed to the outside. By attaching the lid members 14, the second spaces 11, 12 can be closed in a sealed state.

The first wrist element 5 includes flat plate-shaped partition walls 15 that partially partition the first space 10 and the respective second spaces 11, 12. Each of the partition walls 15 is provided with screw holes 17 for fixing the motor 8, 9 to the first space side by means of bolts 16, and a through-hole 18 that penetrates therethrough in the plate thickness direction. The first space 10 and the second spaces 11, 12 communicate with each other in portions other than where the partition walls 15 are.

The respective motors 8, 9 are fixed to the partition walls 15 in a state in which shafts 8a, 9a are made to pass through the through-holes 18 in the partition walls 15.

Bodies of the motors 8, 9 are disposed in the first space 10, and gaps are formed between side surfaces of the bodies and an inner wall of the first wrist element 5. The motor (first motor) 9 drives the second wrist element 6, and the motor (second motor) 8 drives the third wrist element 7.

The shafts 8a, 9a of the respective motors 8, 9, passing through the through-holes 18 in the partition walls 15, respectively protrude from the partition walls 15 toward the second spaces 11, 12. Pulleys 19 are fixed to the shafts 8a, 9a.

The second wrist element 6 is located, on the distal end side of the first wrist element 5, between two distal end portions 5a, 5b bifurcated toward the distal end. The respective distal end portions 5a, 5b are formed in a hollow shape and respectively communicate with the second spaces 11, 12 on both sides of the first space 10. The second wrist element 6 is supported, on both sides thereof in the second axis B direction, by the two distal end portions 5a, 5b so as to be rotatable about the second axis B.

A reduction gear 20 that rotationally drives the second wrist element 6 with respect to the first wrist element 5 is fixed between the second wrist element 6 and the one distal end portion 5a. In addition, the second wrist element 6 and the other distal end portion 5b are rotatably attached to each other by means of a bearing (not shown).

An input shaft 21 of the reduction gear 20 protrudes into the one distal end portion 5a. In addition, an input shaft 23 of a reduction gear 22 that rotationally drives the third wrist element 7 with respect to the second wrist element 6 protrudes into the other distal end portion 5b.

The power input to the input shaft 23 is input to the reduction gear 22 via a pair of gears (not shown). Pulleys 24 are fixed to the respective input shafts 21, 23.

A belt 25 is bridged between the pulley 24 for the input shaft 21 and the pulley 19 for the shaft 9a of the motor 9. In addition, a belt 25 is also bridged between the pulley 24 for the input shaft 23 and the pulley 19 for the shaft 8a of the motor 8.

The pairs of pulleys 19, 24 and the belts 25 constitute power transmission mechanisms (first and second power transmission mechanisms) that respectively transmit the power of the motors 8, 9 to the reduction gears 22, 20. The power transmission mechanisms are respectively located in the second spaces 11, 12.

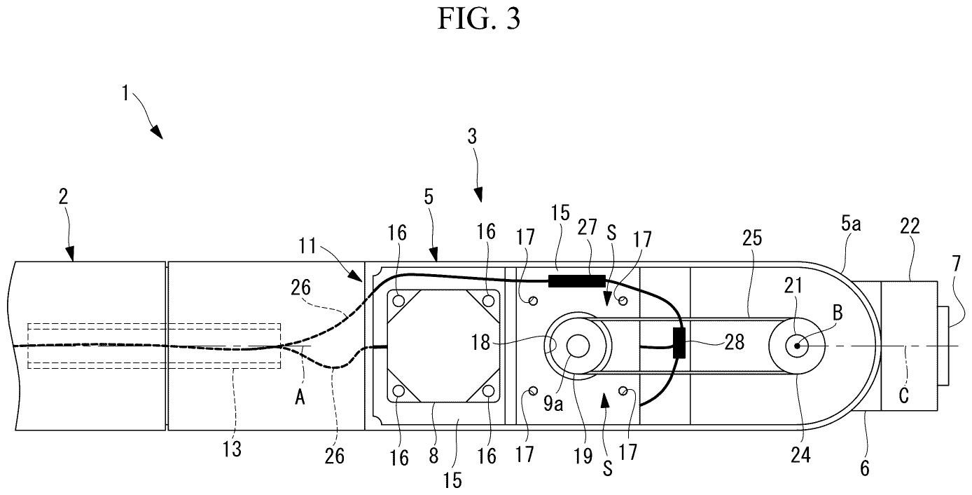

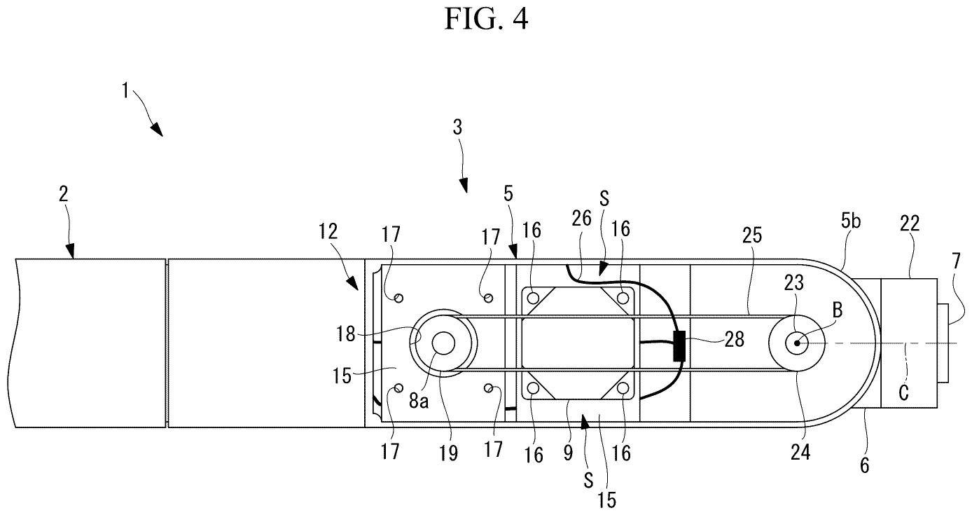

As shown in FIGS. 3 and 4, the outer diameters of the pulleys 19, 24 are both sufficiently smaller than the cross-sectional shapes of the motors 8, 9. In each of the second spaces 11, 12, a space S extending in a direction along the first axis A is provided outside the belt 25 bridged between the pulleys 19, 24.

The space S has a width dimension larger than half of the difference between the width dimension of the motor 8, 9 and the outer diameter of the pulleys 19, 24. In addition, the space S has a dimension in the second axis B direction that is sufficiently larger than the thickness of the pulleys 19, 24.

A wire body 26, such as a cable, that supplies power and signals to the motors 8, 9 enters the first wrist element 5 from the arm 2 side through the hollow pipe 13. As shown in FIG. 1, the wire body 26 led out from the opening at the distal end of the hollow pipe 13 enters the first space 10 of the first wrist element 5. A portion of the wire body 26 is connected to the motor 8 located in the first space 10, on the front side as viewed from the arm 2 side.

In the first space 10, the remaining portion of the wire body 26 passes through a narrow gap between a side wall of the motor 8 and an inner surface of the first wrist element 5, and is led into the one second space 11. Then, the wire body 26 led into the second space 11 passes through the space S provided outside the pulley 19 and the belt 25 on the second space 11 side of the partition wall 15.

When passing through the space S, the wire body 26 is held on the second space 11 side of the partition wall 15 by means of a sheet metal or the like and a binding band or the like (holding member 27). Regarding the shape of the holding member 27 and the holding method, an arbitrary method using materials other than the sheet metal and the binding band may be employed. Subsequently, the wire body 26 is bent toward the first space 10 at a position where the wire body 26 passes beyond the partition wall 15 toward the distal end portion 5a, and enters the first space 10 again.

The wire body 26 that has entered the first space 10 is held by a holding member 28 on the back side further behind the motor 9 on the back side as viewed from the arm 2 side.

As for the holding member 28 also, an arbitrary fixing method using a sheet metal or the like and a binding band or the like may be employed. Then, a portion of the wire body 26 is connected to the motor 9 on the back side.

The remaining portion of the wire body (for example, an air tube etc.) 26 passes through the first space 10 and enters the other second space 12. Then, the wire body 26 returns into the first space 10 again from the second space 12, and is connected to a joint or a connector (not shown) provided in the first wrist element 5.

The operation of the thus-configured robot 1 according to this embodiment will be described below.

A portion of the wire body 26 that has entered the first space 10 from the hollow pipe 13 passes through a narrow gap between the motor 8 and the inner surface of the first wrist element 5.

Then, the wire body 26 that has passed through the gap enters the one second space 11 from the first space 10 side. Because the pulleys 19, 24 and the belt 25 serving as the power transmission mechanism are arranged in an exposed state in the second space 11, the wire body 26 is usually not wired in the vicinity of the power transmission mechanism.

However, the gaps between the motors 8, 9 and the inner surface of the first wrist element 5 are narrow, and it is difficult to reliably fix the wire body 26 in those gaps.

With this embodiment, the motors 8, 9 are fixed to the first space 10 sides of the flat plate-shaped partition walls 15 that partially partition the first space 10 and the second spaces 11, 12.

With this configuration, the pulleys 19, 24 and the belt 25 serving as the power transmission mechanism are arranged on the second space 11, 12 side of the partition wall 15, and the space S extending along the first axis A is formed outside the power transmission mechanism. In addition, the wire body 26 is disposed along the space S, and the wire body 26 is fixed to the second space 11 side of the partition wall 15.

By doing so, it is possible to wire the wire body 26 by utilizing the second space 11 formed for placing the power transmission mechanism.

The second spaces 11, 12 are widely opened by removing the lid members 14. Therefore, it is possible to easily perform the attachment/detachment of the motors 8, 9, the adjustment of the pulleys 19, 24 and the belts 25, and the attachment/detachment of the wire body 26.

In addition, the wire body 26 only passes through the gaps between the motors 8, 9 and the inner surface of the first wrist element 5 and is not fixed therein; thus, it is possible to minimize the size of the gaps. This configuration makes it possible to reduce the size of the first wrist element 5.

Furthermore, a portion of the wire body 26 that has entered the first space 10 through the hollow pipe 13 passes through the second space 11, and is subsequently wired to the motor 9 or the like in the first space 10. With this configuration, it is possible to utilize a large space in which the first space 10 and the second space 11 communicating with each other are combined, thereby ensuring a sufficiently large bending radius of the wire body 26. In other words, by bending the wire body 26 by a large amount using a large space, it is possible to reduce the load on the wire body 26, and the wire body 26 can be wired without difficulty.

Furthermore, another portion of the wire body 26 enters the one second space 11 from the first space 10, passes through the first space 10 again, and enters the other second space 12. Then, the wire body 26 returns into the first space 10 again from the second space 12. With this configuration, it is possible to bend the wire body 26 by a large amount in a larger space in which the first space 10 and the two second spaces 11, 12 on both sides thereof are combined.

In other words, with the robot 1 according to this embodiment, the space S in the second space 11 provided to place the power transmission mechanism is utilized. Because the space S has a cross-sectional dimension that is sufficiently larger than the gap between the motor 8 and the inner surface of the first wrist element 5, the wire body 26 can be prevented from interfering with the surrounding inner wall.

In addition, it is not necessary to specially provide a space S for wiring the wire body 26. It is also possible to facilitate the wiring of the wire body 26 by opening/closing the lid members 14 for opening the second spaces 11, 12.

Furthermore, there is an advantage in that it is possible to reduce the size of the wrist unit 3.

In addition, although the configuration in which the wire body 26 is held on the second space 11 side by means of the holding member 27 has been illustrated as an example in this embodiment, the configuration is not limited thereto.

It is permissible to employ a configuration in which the wire body 26 is led into the other second space 12 and held on the second space 12 side by means of the holding member 27.

### REFERENCE SIGNS LIST

1 robot
2 arm
5 first wrist element
6 second wrist element
7 third wrist element
8 motor (second motor)
9 motor (first motor)
14 lid member
15 partition wall
19, 24 pulley (first power transmission mechanism, second power transmission mechanism)
25 belt (first power transmission mechanism, second power transmission mechanism)
26 wire body
27 holding member
10 first space
11, 12 second space
A first axis
B second axis
C third axis

1. A robot comprising:
a first wrist element supported at a distal end of an arm so as to be rotatable about a first axis;
a second wrist element supported so as to be rotatable with respect to the first wrist element about a second axis orthogonal to the first axis; and
a third wrist element supported so as to be rotatable with respect to the second wrist element about a third axis orthogonal to the second axis,
wherein the first wrist element is provided with a first space accommodating a first motor that drives the second wrist element and a second motor that drives the third wrist element, and second spaces that communicate with the first space and that are respectively disposed on both sides thereof with the first space interposed therebetween in the second axis direction, and
a wire body guided through the arm is guided into the first space through at least one of the second spaces.

2. The robot according to claim 1, wherein the second spaces respectively accommodate a first power transmission mechanism that transmits power of the first motor to the second wrist element and a second power transmission mechanism that transmits power of the second motor to the third wrist element.

3. The robot according to claim 1, further comprising a flat plate-shaped partition wall that partially partitions the first space and each of the second spaces, and to which the first motor or the second motor is fixed,
wherein the wire body passing through the second space is held on the partition wall by means of a holding member.

4. The robot according to claim 3, wherein the first wrist element comprises a lid member attached thereto so as to be detachable in the second axis direction, and removing the lid member opens the second space.
